(19) United States
(12) Patent Application Publication
(10) Pub. No.: US 2012/0030612 A1
(43) Pub. Date: Feb. 2, 2012

(54) DYNAMIC PROPERTY ATTRIBUTES

(75) Inventors: Abdul Aziz, Bangalore (IN); Debobrata Bose, Kolkata (IN); Hilmar Demant, Karlsdorf (DE); Indranil Dutt, Bangalore (IN); Mahesh Gopalan, Bangalore (IN); Niels Hebling, Schriesheim (DE); Jayakanth R, TamilNadu (IN); Vinod S. Nair, Palakkad (IN); Aaby Sivakumar, Kollam (IN)

(73) Assignee: SAP AG, Walldorf (DE)

(21) Appl. No.: 12/847,238

(22) Filed: Jul. 30, 2010

(51) Int. Cl. G06F 3/048

(52) U.S. Cl. 715/781; 715/825

(57) ABSTRACT

A non-transitory recordable storage medium having recorded and stored thereon instructions that, when executed, may perform the actions of assigning an object as a selected object in a property window in response to a selection of the object, the object including a driven property and a driving property, reading one or more properties of the selected object, determining an instance value of the driving property using a custom property descriptor and returning a value of the driven property based on the instance value of the driving property using the custom property descriptor.

### TECHNICAL FIELD

This description relates to dynamic property attributes of an object.

### BACKGROUND

Many businesses and organizations may utilize services (e.g., software applications) that may be provided by one or more providers that may offer user interfaces (UIs) for accessing applications that may be customized for a particular user. For example, a user may desire access via a frontend client device to customer invoice applications that are customized to that particular user. As other examples, the user may also desire access to applications for managing customer relationships, financial management, management of projects, management of supply chain networks, management of supplier relationships, support for executive management, and management of compliance with laws and regulations. Customization may be furnished by the provider, or the user may have a capability to customize particular aspects of an application or service. Further, the provider may host the software and associated data on one or more provider backend devices including host servers. The users may then access the services via remote connections (e.g., via the Internet) using various client frontend devices (e.g., a server local to the user with connecting devices, desktop computers, laptop computers, handheld devices, etc.). The users may then be able to access powerful functionality (e.g., business processes) without requiring a significant up-front investment by the user in extensive Information Technology (IT) personnel and equipment, for example, as part of the user's business setup.

Developers and other users may use tools such as, for example, a design time application to create and design the UIs for eventual use by the frontend client device during a runtime scenario. In a design time application, the attributes of an object may be shown in a framework implementation based on a static definition of a class. In this manner, once the attributes are defined, then those attributes are exposed in a properties window statically based on the attribute definition. Developers and other users may desire more flexibility with respect to configuration options of object attributes.

### SUMMARY

According to one general aspect, a non-transitory recordable storage medium has recorded and stored thereon instructions that, when executed, perform the action of assigning an object as a selected object in a property window in response to a selection of the object, the object including a driven property and a driving property. The instructions, when executed, perform the actions of reading one or more properties of the selected object, determining an instance value of the driving property using a custom property descriptor and returning a value of the driven property based on the instance value of the driving property using the custom property descriptor.

Implementations may include one or more of the following features. For example, the non-transitory recordable storage medium may further include instructions that, when executed, performs the action of displaying the properties in the property window. The instructions that, when executed, perform the action of reading one or more properties of the selected object may include instructions that, when executed, perform the action of determining whether the driven property includes a read-only property attribute and the instructions that, when executed, perform the action of returning the value of the driven property may include instructions that, when executed, perform the actions of overriding the read-only property attribute of the driven property when the read-only property attribute is negative and returning the value of the driven property as editable based on the instance value of the driving property using the custom property descriptor.

The instructions that, when executed, perform the action of reading one or more properties of the selected object may include instructions that, when executed, perform the action of determining whether the driven property includes a read-only property attribute and the instructions that, when executed, perform the action of returning the value of the driven property may include instructions that, when executed, perform the action of returning the value of the driven property as read-only based on the instance value of the driving property using the custom property descriptor.

The instructions that, when executed, perform the action of reading one or more properties of the selected object may include instructions that, when executed, perform the action of determining whether the driven property includes a browsable property attribute and the instructions that, when executed, perform the action of returning the value of the driven property may include instructions that, when executed, perform the action of overriding the browsable property attribute of the driven property when the browsable property is negative and returning the value of the driven property as browsable based on the instance value of the driving property using the custom property descriptor.

The instructions that, when executed, perform the action of reading one or more properties of the selected object may include instructions that, when executed, perform the action of determining whether the driven property includes a browsable property attribute and the instructions that, when executed, perform the action of returning the value of the driven property may include instructions that, when executed, perform the action of returning the value of the driven property as non-browsable based on the instance value of the driving property using the custom property descriptor.

The driving property may include a role property and the instructions that, when executed, perform the action of returning the value of the driven property may include instructions that, when executed, perform the action of returning the value of the driven property based on an instance value of the role property using the custom property descriptor. A first value of the driven property may be returned based on a first instance value of the driving property and a second value of the driven property may be returned based on a second instance value of the driving property, where the first value of the driven property is different from the second value of the driven property and the first instance value is different from the second instance value.

In another general aspect, a method including executing instructions recorded on a non-transitory computer-readable storage media using at least one processor may include assigning an object as a selected object in a property window in response to a selection of the object, the object including a driven property and a driving property, reading one or more properties of the selected object, determining an instance value of the driving property using a custom property descriptor and returning a value of the driven property based on the instance value of the driving property using the custom property descriptor. Implementations may include one or more features as described above with respect to the non-transitory recordable storage medium features.

In another general aspect, a non-transitory recordable storage medium has recorded and stored thereon instructions that, when executed, perform the actions of assigning an embedded component as a selected object in a property window in response to a selection of the embedded component, the embedded component including configuration parameters that are configured to receive configuration values from a consuming component, reading the configuration parameters of the selected embedded component and creating an independent parameter property descriptor for each of the configuration parameters of the embedded component.

Implementations may include one or more of the following features. For example, the non-transitory recordable storage medium may further include instructions that, when executed, perform the action of displaying the independent parameter property descriptors as independent properties in the property window. Each of the independent properties in the property window may be separately selectable. The instructions that, when executed, perform the action of creating the independent parameter property descriptor may include instructions that, when executed, perform the action of creating the independent parameter property descriptor for each of the configuration parameters of the embedded component using a custom property descriptor for each of the configuration parameters.

In another general aspect, a method including executing instructions recorded on a non-transitory computer-readable storage media using at least one processor may include assigning an embedded component as a selected object in a property window in response to a selection of the embedded component, the embedded component including configuration parameters that are configured to receive configuration values from a consuming component, reading the configuration parameters of the selected embedded component and creating an independent parameter property descriptor for each of the configuration parameters of the embedded component.

Implementations may include one or more of the following features. For example, the method may further include displaying the independent parameter property descriptors as independent properties in the property window. Each of the independent properties in the property window may be separately selectable. The method may include creating the independent parameter property descriptor for each of the configuration parameters of the embedded component using a custom property descriptor for each of the configuration parameters.

In another general aspect, a computer system includes instructions stored on a non-transitory computer-readable storage medium and the computer system includes a view editor that is arranged and configured to assign an object as a selected object in a property window in response to a selection of the object, the object including a driven property and a driving property. The computer system includes a custom property manager that is arranged and configured to read one or more properties of the selected object, determine an instance value of the driving property using a custom property descriptor and return a value of the driven property based on the instance value of the driving property using the custom property descriptor.

Implementations may include one or more of the following features. For example, the view editor may be further configured to display the properties in the property window. The custom property manager may be arranged and configured to determine whether the driven property includes a read-only property attribute and override the read-only property attribute of the driven property when the read-only property attribute is negative and return the value of the driven property as editable based on the instance value of the driving property using the custom property descriptor. The custom property manager may be arranged and configured to determine whether the driven property includes a read-only property attribute and return the value of the driven property as read-only based on the instance value of the driving property using the custom property descriptor.

The custom property manager may be arranged and configured to determine whether the driven property includes a browsable property attribute and override the browsable property attribute of the driven property when the browsable property is negative and return the value of the driven property as browsable based on the instance value of the driving property using the custom property descriptor. The custom property manager may be arranged and configured to determine whether the driven property includes a browsable property attribute and return the value of the driven property as non-browsable based on the instance value of the driving property using the custom property descriptor.

In one exemplary implementation, the driving property may include a role property and the custom property manager may be arranged and configured to return the value of the driven property based on an instance value of the role property using the custom property descriptor. A first value of the driven property may be returned based on a first instance value of the driving property and a second value of the driven property may be returned based on a second instance value of the driving property, where the first value of the driven property is different from the second value of the driven property and the first instance value is different from the second instance value.

The details of one or more implementations are set forth in the accompanying drawings and the description below. Other features will be apparent from the description and drawings, and from the claims.

### BRIEF DESCRIPTION OF THE DRAWINGS

FIG. 1 is an exemplary screen shot of a design time application illustrating an editable property scenario.

FIG. 2 is an exemplary screen shot of a design time application illustrating a read-only property scenario.

FIG. 3 is an exemplary flow diagram.

FIG. 4 is an exemplary table of a class diagram.

FIG. 5 is an exemplary flow diagram related to an embedded component.

FIG. 6 is a block diagram of an example model-view-controller structure.

FIGS. 7a-7b are block diagrams illustrating an example component structure.

FIG. 8 is a block diagram of an example declarative interface structure for components.

FIG. 9 is a block diagram of an example structure for a component wrapper.

FIG. 10 is a block diagram of an example runtime client.

FIG. 11 is a block diagram of an example runtime backend device.

FIG. 12 is a block diagram of an example design time client.

### DETAILED DESCRIPTION

This document describes systems and techniques for enabling a developer and other users of UIs to change the behavior of object attributes from a static behavior to a dynamic behavior. In one exemplary implementation, the behavior of one or more object attributes includes extending the metadata at runtime and exposing the static declarations of the attributes, which enables a user to implement dynamic configurations of the attributes. For example, a developer may implement whether one attribute is read-only or editable or available at all, based on a value of another property. Also, in another example, a developer may implement whether one attribute is browsable or not based on a value of another property.

This document also describes systems and techniques to implement a dynamic behavior of a property to enable one or more roles, which may be associated with a specific user. For example, a user with the role of a developer may have access rights to one or more properties of an object based on the defined user's role as a developer. In contrast, a user with a different role may not have access rights to the same properties of the object based on the user's defined role.

This document also describes systems and techniques to implement a dynamic behavior of the parameters of an embedded component. For example, one or more of the properties in the embedded component may include dynamic properties based on one or more values of a consuming component in which the embedded component is embedded.

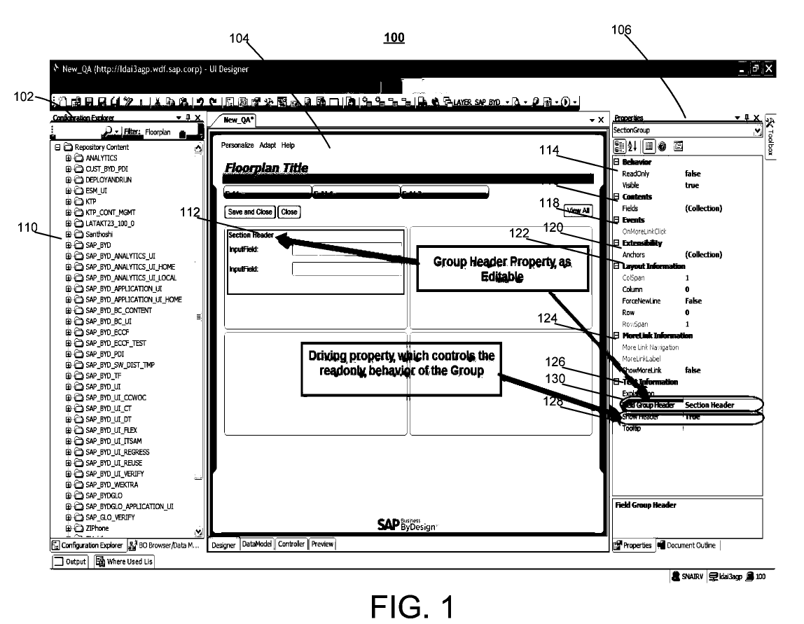

FIG. 1 is an exemplary screen shot 100 of a design time application illustrating an editable property scenario. A design time application may include an application that is used to develop and maintain an end-to-end user interface (UI). The design time application may be an integrated tool that allows the creation and maintenance of a UI, including all of the UI components, end-to-end starting from early mockups and through an entire development process. The UIs may be modeled and controller logic for the UIs may be implemented in the design time application.

In one exemplary implementation, the design time application may be accessed and used as a stand-alone application, through a browser or as a plug-in to other application programs, including as a plug-in to a browser. For example, the design time application may be used with an application programs such as an Internet web-browser such as the FIREFOX web browser, the APPLE SAFARI web browser, the MICROSOFT INTERNET EXPLORER web browser, or the GOOGLE CHROME web browser.

As illustrated in the exemplary screen shot 100, one view of the design time application shows multiple different windows. The windows may include a configuration explorer window 102, a floorplan window 104, and a properties window 106. The design time application also may include other windows and views, which are not shown in exemplary screen shot 100. For instance, the tabs 108 indicate that other views having other functionality are possible such as a designer view, a datamodel view, a controller view and a preview view. In this example, the designer view is selected and illustrated.

The design time application may be configured as a single design tool to enable different users having different roles to access and create UI components, as may be appropriate to their role. Each role may include one or more different views in the design time application and may include different data rights and access rights. The design time applications is configured to support specific views tailored for specific roles and to provide collaboration tools and a collaboration environment to support the overall development process for UI components. The design time application may be configured to enable visual editing, including drag and drop features and in-place text editing.

In one exemplary implementation, the design time application may be implemented using a .NET framework-based platform. In other exemplary implementations, the design time application may be implemented using a different framework or combinations of frameworks.

The configuration explorer window 102 illustrates a hierarchical folder view 110 of the content of a metadata repository. The configuration explorer window 102 enables a user to browse the data that is stored in the metadata repository. The design time application is configured to read data from the metadata repository and is configured to write data to the metadata repository. The metadata repository may include a repository that is configured to store the all of the UI entities in a central repository. In one exemplary implementation, the UI metadata may include configuration files, which may be source-based configuration files using an extensible markup language (XML) format. In one exemplary implementation, the metadata repository may reside on server and the design time application may access and interface with the metadata repository on the server.

The folders 110 listed in the configuration explorer window 102 may include a listing of UI components. The listed UI components may include different types of UI components and the UI components may be selectable by a user for display in the design time application. A selected UI component may be modified by a user having an appropriate role and/or rights. In addition to selecting and modifying an existing component stored in the metadata repository, a new UI component may be created and written to the metadata repository.

The UI component configuration files may be invoked at runtime on a client device running a client application, which also has access to the same metadata repository. The client application may include a client engine that is configured to interpret the configuration file at runtime and to render the UI component as a physical representation in the client application on a client device.

The floorplan window 104 is an area of the design time application that is configured to enable the creation and/or modification of UI components. In one exemplary implementation, the floorplan window 104 may provide access to multiple different, pre-defined floorplan views. One view may be a quick activity view. For example, a configuration file for an object that is selected from the configuration explorer window 102 may be graphically displayed in the floorplan window 104.

In the exemplary screen shot 100, the floorplan window 104 illustrates a graphical view of a SectionGroup object 112. In this example, the SectionGroup object 112 displays a section header with two input fields.

The properties window 106 is an area of the design time application that is configured to enable the selection and configuration of one or more properties of a selected object. For example, the properties of an object, which has been selected from the configuration explorer window 102, may be displayed in the properties window 106. The properties window 106 provide the capability to configure the selected object. For example, if the selected object is a button, the properties of the button may be configured such as the click properties of the button, the icon association properties of the button, the label properties of the button and the tool tip properties of the button.

In the exemplary screen shot 100, the properties window 106 illustrates multiple different properties of the selected object SectionGroup 112. The properties that are populated in the properties window 106 include a behavior property 114, a contents property 116, an events property 118, an extensibility property 120, a layout information property 122, a morelink information property 124 and a text information property 126.

As discussed above, in one exemplary implementation, the design time application, including the properties window 106, may be implemented using a .NET framework. The properties window 106 may be configured to expose the configurable properties of selected objects, as shown in the example screen shot 100.

In some typical .NET framework implementations, the value of an attribute of a property may be set when the object is first defined and once the value is set, then the corresponding property as displayed in the properties window 106 will always be shown as that value. For example, the ReadOnlyAttribute can be set only while defining the object and once this attribute is set, the corresponding property of this object will always be shown as Read-Only in the property window. However, there are many use cases where it would be useful if the property could be made editable in some scenarios and read-only in other scenarios, instead of always being read-only.

In one exemplary implementation, a Custom Type Descriptor may be used to make one property of an object, a driven property, dependent on the value of another property, a driving property. For example, even though a ReadOnlyAttribute is set for a driven property, the value of a driving property may override the ReadOnlyAttribute and make the driven property editable using a Custom Type Descriptor. In the example screen shot 100, the Show Header property 128 is a driving property and the Field Group Header property is a driven property. The instance value of the Show Header property 128 determines whether or not the value of the Field Group Header property 130 is read-only or editable. The instance value of a property is the value of the property is a particular instance or particular context. The instance value of a property may change depending on the context in which the property or the object is being used, accessed, and/or displayed. In this example, the instance value of the Show Header property 128 is positive (e.g., true), so the Field Group Header property 130 is editable, even if the ReadOnlyObject had been previously set when defining the object. In this manner, the instance value of the driving property controls the behavior of the value of the driven property.

In another exemplary implementation, one or more coded breakouts may be used to determine a resulting value of a driven property as an alternative to using one or more declarations. In this manner, the coded breakout may be used, either alone or in conjunction with one or more declarations, should the declarative capabilities not be fully suited or enough.

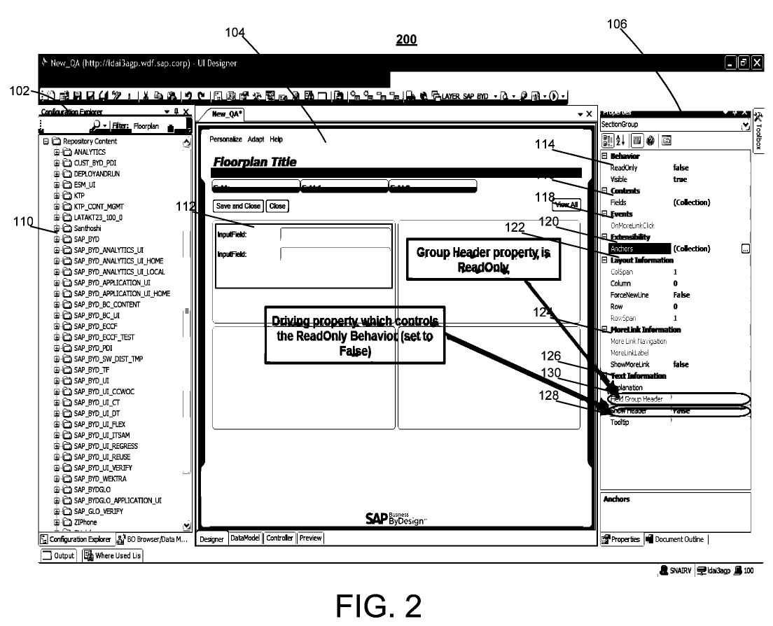

Referring to FIG. 2, an exemplary screen shot 200 is illustrated. The screen shot 200 illustrates the design time application and the same windows as illustrated in the exemplary screen shot 100 of FIG. 1. In contrast to screen shot 100, screen shot 200 illustrates that the instance value of the driving property 128 is negative (e.g., false), so the Field Group Header property 130 is read-only. In this same manner as FIG. 1, the instance value of the driving property controls the value of the driven property.

In other exemplary implementations, different property attributes may be overridden from their initial setting during the definition of the object and instead may be dynamically changed based on the instance value of a driving property. For example, the BrowsablePropertyAttribute may be defined as one value during the definition stage of the object. However, using a Custom Property Descriptor, the BrowsablePropertyAttribute may be overridden and instead a driven property may be either browsable or non-browsable based on the instance value of a driven property.

In other exemplary implementations, the driving property may include multiple driving properties. In this manner, the instance values of the multiple driving properties may control the value of a driven property. In one implementation, only if all of the driving property conditions are met, then the driven property is set to true or false, as the case may be. Otherwise, if all of the driving property conditions are not met, then the opposite value is set for the driven property.

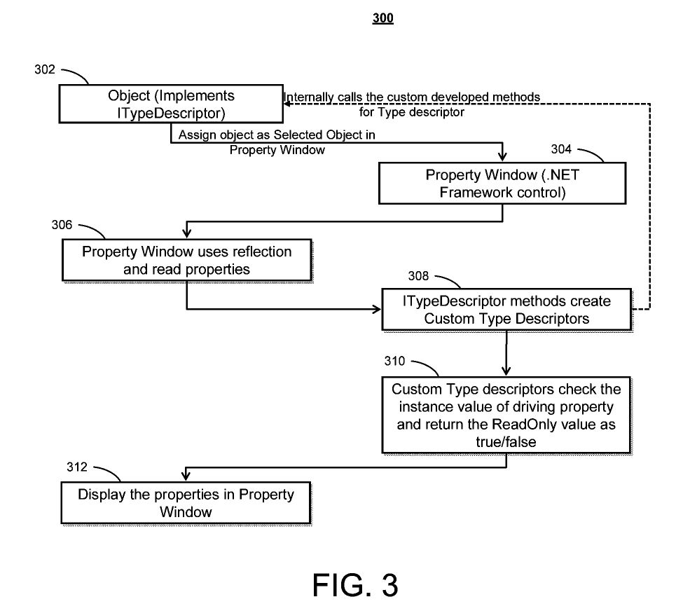

Referring to FIG. 3, an exemplary flow diagram 300 is illustrated. The flow diagram 300 illustrates an exemplary flow to implement the example scenarios described in FIGS. 1 and 2. A selected object may be assigned in the property window (302). The selection of the object and its assignment to the property window may invoke and implement an ITypeDescriptor. For example, the selection by a user of one of the objects from the configuration explorer window 102 of FIG. 1 may cause the selected object to be displayed graphically in the floorplan window 104 and may cause the object to be assigned in the properties window 106 (304). The ITypeDescriptor may represent a data structure. A Type Descriptor may be an architecture that enables different capabilities and functionalities in a framework environment. In one exemplary implementation, the Type Descriptor class may support different properties.

The property window may use reflection and read the properties of the selected object (306). Reflection enables a user to obtain information about loaded objects and the types defined within them, such as classes, interfaces and value types. Reflection also may be used to create type instances at run time and to invoke and access the type instances. For example, the property window 106 may use reflection to read the properties from the selected object.

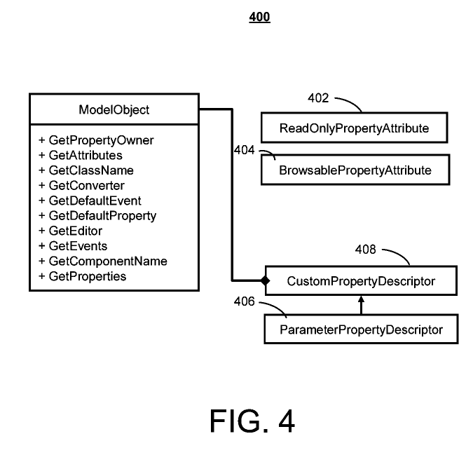

The ITypeDescriptor methods may be used to create custom type descriptors (308). Referring also to FIG. 4, a table 400 illustrates a class diagram of the classes which may be used to implement the dynamic property attributes behavior. The design time application may include its own Model Object, which may include a root class from which other models are derived. Model Object may be the base type for designer specific models and may implement the methods which may be shown in a class diagram. The table 400 illustrates examples of new classes such as ReadOnlyPropertyAttribute 402 and BrowsablePropertyAttribute 404. The ParameterPropertyDescriptor 406 may be configured to get the root type descriptor for the parameter, which in this example is the CustomPropertyDescriptor 408.

The Model Object implements all of the methods shown in the class diagram, which are declared in the ICustomTypeDescriptor interface exposed by the .NET libraries. Setting the selected object on the property window internally calls the GetProperties method, which returns a PropertyDescriptor Collection.

Referring back to FIG. 3, the Custom Type descriptors check the instance value of the driving property and return the value of the driven property as true or false (310). In this example, the driven property value is a read-only attribute so that the instance value of the driving property is checked and it returns the read-only value as true or false. In one exemplary implementation, the CustomPropertyDescriptor wraps the default PropertyDescriptor and overrides the value of the driven property, which, in this example, is the IsReadOnly property and checks whether the selected object property has the ReadOnlyPropertyAttribute implemented. If the ReadOnlyPropertyAttribute is implemented, then the instance value of the driving property is checked using reflection. Then, the value of the driven property is returned based on the instance value of the driving property.

The properties may be displayed in the property window (312). For example, the properties, including the driving property and the driven property and their respective values may be displayed in the property window 106. In this manner, the value of one property may override a static value of another property and dynamically change the value of the other property.

In one exemplary implementation, any property may be a driving property. Additionally, for a particular context, the driving property may change. For example, a driven property may be associated with more than one driving property. In a first context, a value of the driven property may be returned based on an instance value of a first driving property. In a second context, which is different than the first context, a value for the same driven property may be returned based on an instance value of a second driving property, where the second driving property is different from the first driving property.

In another exemplary implementation, a role property may be a driving property. A role property may be one which determines the data access and/or editing rights of a user. In this manner, the value of the role property may return the value of a driven property. For example, if the instance value of the role property is true, then the driven property may be accessible and/or editable by the user. In the instance value of the role property is false, then the driven property may not be accessible and/or may be read-only by the user. The instance value may be determined, at least in part, on the context in which the particular user is operating in the design time application.

In another exemplary implementation, flow diagram 300 of FIG. 3 and the class diagram 400 of FIG. 4 may be used to implement a BrowsablePropertyAttribute in the same manner as the ReadOnlyPropertyAttribute. An IsBrowsable property may be dynamically calculated in the CustomPropertyDescriptor with the BrowsablePropertyAttribute. Additionally, in the Model Object GetProperties method where the CustomPropertyDescriptor is created, a check is performed to find the current value of IsBrowsable. If true, then the instance of the created CustomPropertyDescriptor is added to the collection for processing. If false, then the instance of the created CustomPropertyDescriptor is skipped.

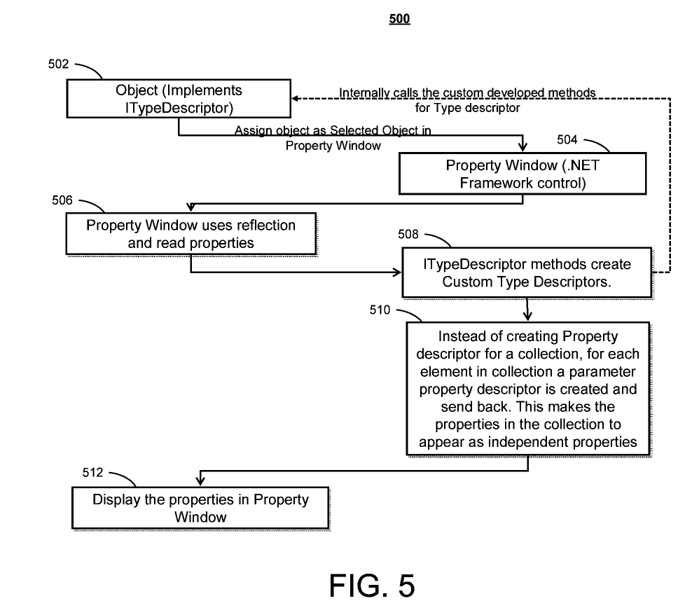

In another exemplary implementation, the configuration parameters of an embedded component may be independently displayed as independent properties in the property window. An embedded component is a UI component which may be used as a part of another UI component, which may be referred to as a consuming component. The embedded component may include configuration parameters, where the configuration parameters are typically displayed as a collective group in the property window. The parameters in the collective group are not separately selectable. Referring to FIG. 5, a flow diagram 500 is illustrated. The flow diagram 500 illustrates a process to implement the configuration parameters of an embedded component as independent and separately configurable properties in the property window.

The flow diagram 500 includes assign the embedded component as a selected object in the property window (502). For example, the user may select an embedded component from the list of object in the configuration explorer window 102 of FIG. 1. Similarly to flow diagram 300 of FIG. 3, the flow diagram 500 of FIG. 5 may include the same or similar steps. For example, the selection by a user of one of the objects from the configuration explorer window 102 of FIG. 1 may cause the selected object to be displayed graphically in the floorplan window 104 and may cause the object to be assigned in the properties window 106 (504). The property window may use reflection and read the properties of the selected object (506). The ITypeDescriptor methods may be used to create custom type descriptors (508).

Instead of creating a single property descriptor for the collection configuration parameters, for each configuration parameter element in the collection, a parameter property descriptor is created and sent back, which causes each of the configuration properties in the collection to appear as independent properties (510). The independent properties are displayed in the property window (512).

In this manner, this enables a developer to choose from the fields that are now exposed in the interface of the embedded component. A specific configuration parameter property, which is now individually displayed in the property window, may be selected and configured for use in a specific context. These previously static configuration parameters are now exposed to the developer as independently selectable and configurable properties in the property window.

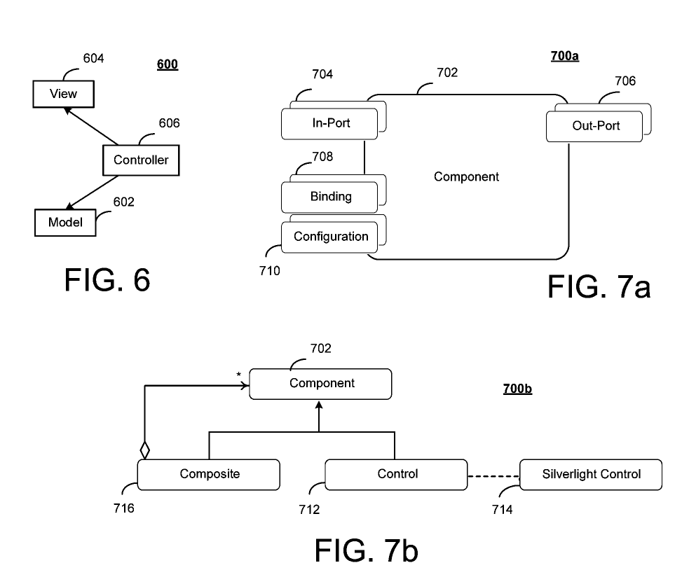

FIG. 6 is a block diagram of an example model-view-controller structure 600. Model-view-controller (MVC) is an architectural pattern used in software engineering. In an MVC context, a model 602 may represent information or data of an application. A view 604 may correspond to elements of a user interface such as text, buttons, checkbox items, etc. A controller 606 manages the communication of data and the rules used to manipulate the data to and from the model. FIG. 6 shows the dependencies among the model 602, view 604, and the controller 606.

FIGS. 7a-7b are block diagrams illustrating an example component structure. According to an example embodiment, a UI component 702 may include a self contained model of a UI that may be declaratively used in another UI model. A declarative interface 700a of a UI component 702 may include in-ports 704 and out-ports 706. These ports may be used to implement a loosely coupled behavior in embedding or navigation scenarios. The data of a loosely coupled component may be loaded asynchronous (i.e., an additional roundtrip between the frontend and backend may be needed). The declarative interface 702 may also include binding 708, for tightly coupled behavior in embed scenarios (e.g., synchronous loading), working directly on the data model of a parent UI model (e.g., via references to the parent data model). The declarative interface 700a may also include configuration 710. A technical configuration may be exposed, e.g., to enable a user to support different styles/flavors, e.g., statically set at design time.

As shown in a logical component model 700b of FIG. 7b, a component 702 may be a control 712 provided by a system framework or implemented in association with framework controls (e.g., a Silverlight control 714). A component 702 may be a composite 716 (e.g., composite control, building block, etc.) which may include other components (e.g., nested composites and/or controls). Components 702 may expose an interface or interfaces for actions, ports and bindings. A composite may be used and configured in a view-composition or used as the target of a navigation as a standalone UI application. The configuration of a non-framework component may be generated via the exposed declared interface.

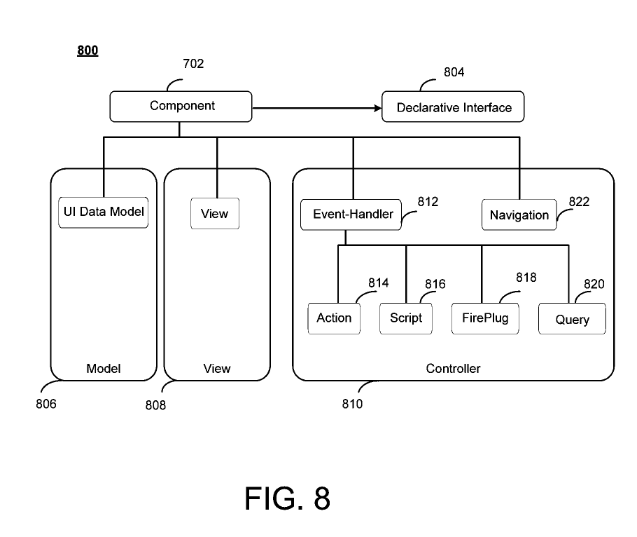

FIG. 8 is a block diagram of an example declarative interface structure 800 for components. A component 702 may include a declarative interface 804, a model 806, a view 808, and a controller 810. For example, a view 808 may include a description of the user interface which binds to a UI data model 806 and triggers event-handlers 812. The UI data model 806 may describe data structure, which can bind to backend data. The controller 810 may recognize various types of event-handlers 812 such as business object actions 814, script 816, plug-operations 818 and queries 820. According to an example embodiment, navigation 822 may include a context-mapping for outplug-inplug-operations. The declarative interface 804 may expose ports, binding-capabilities and configuration to the composition environment.

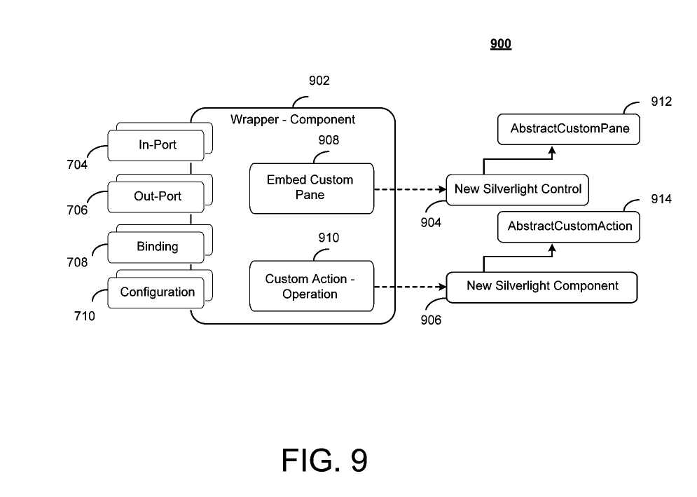

FIG. 9 is a block diagram of an example structure 900 for a component wrapper 902. According to an example embodiment, native Silverlight components may be generated (e.g., Silverlight control 904, Silverlight component 906) which can interact with the component data model and may participate in events. A developer may implement interfaces and use these components via a custom pane 908 in an EmbedComponent-Type, and via a custom action operation 910, respectively. Through this a declared interface wrapper may use these components in other components. Custom panes may be utilized via EmbedComponents and may be associated with a control derived from AbstractCustomPane 916 for controls or from Abstract CustomAction 914 for action components. According to an example implementation, custom panes that are configured in EmbedComponents may point to an assembly name and class type name of a control derived from the framework AbstractCustomPane. Embedcomponents may be used in other components, as this provides a capability at designtime to reflect on the declarative interface of the wrapper component.

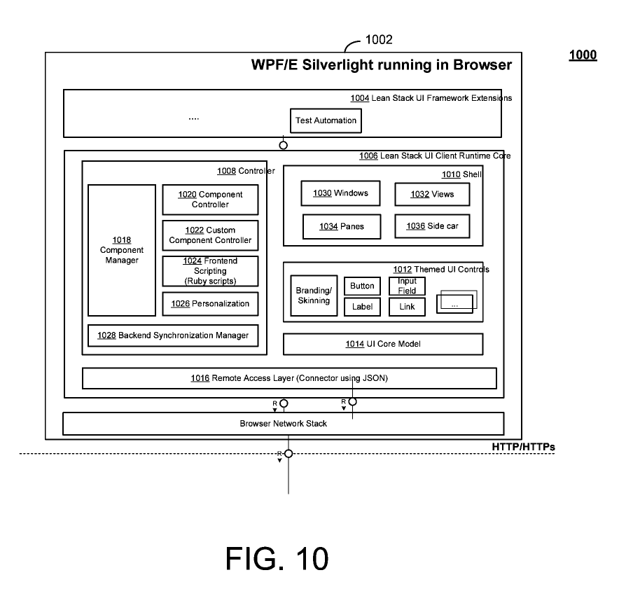

FIG. 10 is a block diagram of an example runtime client 1000. As shown in FIG. 10, Silverlight 1002 is running in the client program (e.g., a browser). The system includes lean stack UI framework extensions 1004. The system further includes a lean stack UI client runtime core 1006, which includes a controller 1008, a shell 1010, themed UI controls 1012, a UI core model 1014, and a remote access layer 1016. The controller 1008 includes a component manager 1018 for managing components, which were discussed previously. The controller 1008 also includes a component controller 1020, a custom component controller 1022, a frontend scripting engine 1024, a personalization engine 1026, and a backend synchronization manager 1028. The shell 1010 includes windows 1030, views 1032, panes 1034, and side cars 1036.

User requests may be triggered on the client side during UI runtime. The first user request may be a navigation request that results in a request to the backend to read a UI component. The UI component is read from a central metadata repository in the backend and transported to the frontend. The component manager 1018 may instantiate the UI component and a corresponding component controller 1020 for the UI component on the client side and triggers the initialization of the UI component on the backend side. The component manager 1018 generates a control tree for the UI component out of the controls provided in a central “Themed Controls” 1012 package. These controls ensure uniform look and feel and the ability to change themes consistently. The controls in the “themed UI controls” package may be enabled in a consistent way for test automation and accessibility, and may be provided in a manner such that all native implemented custom UI panes may use the controls. More than one UI component may be needed to render a UI, as UI components may embed other UI components (e.g., a Work Center component may embed a Work Center View Component and they again may embed OWL components, etc.). The top-level UI component that is rendered is a root UI component which renders a common frame for all UI components, e.g., by rendering the top level navigation and has an ability to open a side car for personalization and help.

For each UI component the “generic” component controller 1020 for that particular component is instantiated. If a custom UI pane is to be rendered then a corresponding custom component controller 1022 may be instantiated. The component controller 1020 ensures that all controls are bound to the proper fields of the UI model and executes all operations that are configured in the event handlers of the UI component. If, some script segments are discovered in the event handlers, the controller triggers the execution of these scripts in the frontend scripting engine 1024. The component controller 1020 may also trigger a roundtrip to the backend device. In that case the backend synchronization manager 1028 identifies all changed data in the UI data model in the client and packs only the changed data in a request to the backend. After the backend controller computes the data in the backend all changed data and only the changed data from the backend (including all data changed via side effects) may be transported back to the frontend.

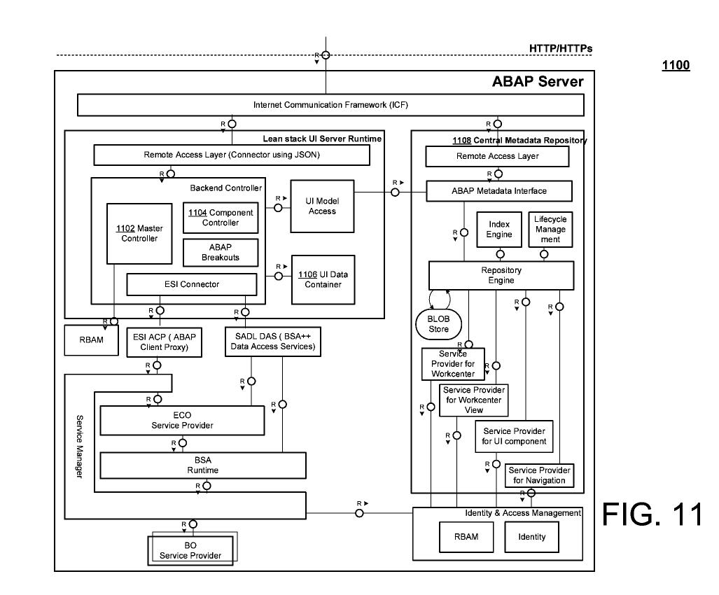

FIG. 11 is a block diagram of an example runtime backend device 1100. After the client runtime 1000 (as discussed above) triggers the initialization of a UI component in the backend for a first time in a session, the UI server runtime 1100 may first create a master controller 1102 for the complete session and then may generate a component controller 1104 for each component that is requested from the client runtime 1000. Each component controller 1104 may build a UI data container 1106 from the information of the UI model for a component. The master controller 1102 may handle the choreography of the different controllers and may build a bracket for all operations targeted for one controller. The master controller 1102 may also trigger another runtime and provide the other runtime with all relevant metadata. Relevant information is stored within the models of the UI components.

After the master controller 1102 has processed all component controllers 1104, it collects all the data that has changed in the UI data container 1106 and transports all changed data to the client.

As discussed previously, the UI components may be stored in a central metadata repository 1108 on the backend device.

According to an example embodiment, communications between components may be modeled via semantic navigation targets. In this instance, target components are not named directly, but navigation may be invoked based on a host business object and an operation. An operation may be a standard-operation (e.g., display, edit, list, etc.) or a custom operation introduced in a navigation registry. The in- and out-ports of a UI component may be used in the definition of a navigation to identify the involved UI components for the runtime.

A navigation provider may thus replace dynamically at component load/generation time the semantic navigation targets by UI components. This concept allows flexibility regarding determination of navigation targets according to use cases. The semantics of a business object and an operation (e.g., SalesOrder-Open) may be used as a navigation query for requesting a navigation target. Each application UI to be used as a navigation target defines a business object and an operation name as navigation target descriptor to indicate which navigation requests it supports.

To support some special use cases (e.g., globalization, verticalization) a third parameter beside business object and operation may be made available which has no fixed semantic but can be defined by the applications (e.g., in some cases this third parameter is the country for which a special UI component has to be launched).

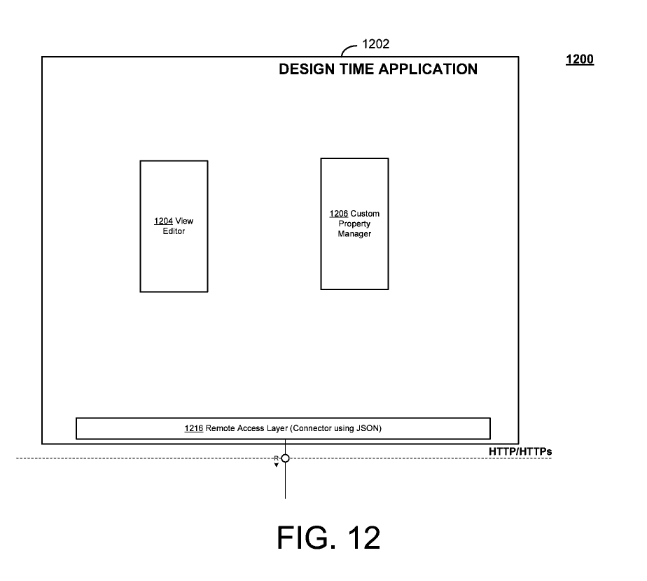

Referring to FIG. 12, a block diagram of example design time client 1200 is illustrated. The design time client may interface with the same backend device 1100 of FIG. 11 as the runtime client 1000 of FIG. 10. As discussed above with respect to the screen shots 100 and 200 of FIGS. 1 and 2, respectively, the design time application 1202 enables users to create and/or modify the UI components, which are stored in the central repository of the backend device 1100 and interpreted and rendered during run time on the runtime client 1000. For simplicity of illustrations, only a few components of the design time application 1202 are illustrated. The design time client 1200 may interface and access the backend device 1100 through a remote access layer 1216 in a manner similar to the runtime client.

The design time application 1202 may be configured to implement the features and functionality described above with respect to FIGS. 1-5. For example, a view editor 1204 may be configured to assign an object as a selected object in a property window in response to a selection of the object. A custom property manager 1206 may be configured to read one or more properties of the selected object, determine an instance value of the driving property using a custom property descriptor and return a value of the driven property based on the instance value of the driving property using the custom property descriptor.

In a similar manner, when the selected object is an embedded component, the custom property manager 1206 may be configured to create an individual configuration parameter property for each configuration parameter and to display them as independent properties in the property window.

Implementations of the various techniques described herein may be implemented in digital electronic circuitry, or in computer hardware, firmware, software, or in combinations of them. Implementations may be implemented as a computer program product, i.e., a computer program tangibly embodied in a non-transitory machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A non-transitory recordable storage medium having recorded and stored thereon instructions that, when executed, perform the actions of:
assigning an object as a selected object in a property window in response to a selection of the object, the object comprising a driven property and a driving property;
reading one or more properties of the selected object;
determining an instance value of the driving property using a custom property descriptor; and
returning a value of the driven property based on the instance value of the driving property using the custom property descriptor.

2. The non-transitory recordable storage medium of claim 1 further comprising instructions that, when executed, performs the action of displaying the properties in the property window.

3. The non-transitory recordable storage medium of claim 1 wherein:
the instructions that, when executed, perform the action of reading one or more properties of the selected object comprise instructions that, when executed, perform the action of determining whether the driven property includes a read-only property attribute; and
the instructions that, when executed, perform the action of returning the value of the driven property comprise instructions that, when executed, perform the actions of overriding the read-only property attribute of the driven property when the read-only property attribute is negative and returning the value of the driven property as editable based on the instance value of the driving property using the custom property descriptor.

4. The non-transitory recordable storage medium of claim 1 wherein:
the instructions that, when executed, perform the action of reading one or more properties of the selected object comprise instructions that, when executed, perform the action of determining whether the driven property includes a read-only property attribute; and
the instructions that, when executed, perform the action of returning the value of the driven property comprise instructions that, when executed, perform the action of returning the value of the driven property as read-only based on the instance value of the driving property using the custom property descriptor.

5. The non-transitory recordable storage medium of claim 1 wherein:
the instructions that, when executed, perform the action of reading one or more properties of the selected object comprise instructions that, when executed, perform the action of determining whether the driven property includes a browsable property attribute; and
the instructions that, when executed, perform the action of returning the value of the driven property comprise instructions that, when executed, perform the action of overriding the browsable property attribute of the driven property when the browsable property is negative and returning the value of the driven property as browsable based on the instance value of the driving property using the custom property descriptor.

6. The non-transitory recordable storage medium of claim 1 wherein:
the instructions that, when executed, perform the action of reading one or more properties of the selected object comprise instructions that, when executed, perform the action of determining whether the driven property includes a browsable property attribute; and
the instructions that, when executed, perform the action of returning the value of the driven property comprise instructions that, when executed, perform the action of returning the value of the driven property as non-browsable based on the instance value of the driving property using the custom property descriptor.

7. The non-transitory recordable storage medium of claim 1 wherein:
the driving property comprises a role property and the instructions that, when executed, perform the action of returning the value of the driven property comprise instructions that, when executed, perform the action of returning the value of the driven property based on an instance value of the role property using the custom property descriptor.

8. The non-transitory recordable storage medium of claim 1 wherein:
a first value of the driven property is returned based on a first instance value of the driving property; and
a second value of the driven property is returned based on a second instance value of the driving property, wherein the first value of the driven property is different from the second value of the driven property and the first instance value is different from the second instance value.

9. A non-transitory recordable storage medium having recorded and stored thereon instructions that, when executed, perform the actions of:
assigning an embedded component as a selected object in a property window in response to a selection of the embedded component, the embedded component comprising configuration parameters that are configured to receive configuration values from a consuming component;
reading the configuration parameters of the selected embedded component; and
creating an independent parameter property descriptor for each of the configuration parameters of the embedded component.

10. The non-transitory recordable storage medium of claim 9 further comprising instructions that, when executed, perform the action of displaying the independent parameter property descriptors as independent properties in the property window.

11. The non-transitory recordable storage medium of claim 10 wherein each of the independent properties in the property window is separately selectable.

12. The non-transitory recordable storage medium of claim 9 wherein the instructions that, when executed, perform the action of creating the independent parameter property descriptor comprise instructions that, when executed, perform the action of creating the independent parameter property descriptor for each of the configuration parameters of the embedded component using a custom property descriptor for each of the configuration parameters.

13. A computer system including instructions stored on a non-transitory computer-readable storage medium, the computer system comprising:
a view editor that is arranged and configured to assign an object as a selected object in a property window in response to a selection of the object, the object comprising a driven property and a driving property; and
a custom property manager that is arranged and configured to:
read one or more properties of the selected object;
determine an instance value of the driving property using a custom property descriptor; and
return a value of the driven property based on the instance value of the driving property using the custom property descriptor.

14. The computer system of claim 13 wherein the view editor is further configured to display the properties in the property window.

15. The computer system of claim 13 wherein the custom property manager is arranged and configured to:
determine whether the driven property includes a read-only property attribute; and
override the read-only property attribute of the driven property when the read-only property attribute is negative and return the value of the driven property as editable based on the instance value of the driving property using the custom property descriptor.

16. The computer system of claim 13 wherein the custom property manager is arranged and configured to:
determine whether the driven property includes a read-only property attribute; and
return the value of the driven property as read-only based on the instance value of the driving property using the custom property descriptor.

17. The computer system of claim 13 wherein the custom property manager is arranged and configured to:
determine whether the driven property includes a browsable property attribute; and
override the browsable property attribute of the driven property when the browsable property is negative and return the value of the driven property as browsable based on the instance value of the driving property using the custom property descriptor.

18. The computer system of claim 13 wherein the custom property manager is arranged and configured to:
determine whether the driven property includes a browsable property attribute; and
return the value of the driven property as non-browsable based on the instance value of the driving property using the custom property descriptor.

19. The computer system of claim 13 wherein:
the driving property comprises a role property; and
the custom property manager is arranged and configured to return the value of the driven property based on an instance value of the role property using the custom property descriptor.

20. The computer system of claim 13 wherein:
a first value of the driven property is returned based on a first instance value of the driving property; and
a second value of the driven property is returned based on a second instance value of the driving property, wherein the first value of the driven property is different from the second value of the driven property and the first instance value is different from the second instance value.
